(19) United States
(12) Patent Application Publication
(10) Pub. No.: US 2026/0299345 A1
(43) Pub. Date: Oct. 1, 2026

(54) DISPLAY DEVICE

(71) Applicant: LG Display Co., Ltd., Seoul (KR)

(72) Inventors: Ahram CHO, Gumi-si (KR); SeongDo KIM, Daegu (KR)

(73) Assignee: LG Display Co., Ltd., Seoul (KR)

(21) Appl. No.: 19/432,495

(22) Filed: Dec. 24, 2025

(30) Foreign Application Priority Data
Mar. 27, 2025 (KR) 10-2025-0039432

(51) Int. Cl. G02F 1/1333; F21V 8/00

(52) U.S. Cl. CPC G02F 1/133322; G02B 6/0086; G02F 1/133331

(57) ABSTRACT

A display device can include a display panel configured to display an image, a cover glass disposed above the display panel, a cover bottom disposed below the display panel and configured integrally by including a lower portion and a first side portion and a second side portion disposed inside the first side portion, and a guide panel configured to surround the display panel and the cover bottom under the cover glass and laterally fastened to the first side portion of the cover bottom, thereby increasing rigidity and reducing deformation compared to a cover bottom having a single structure, and providing an effect of satisfying a noise standard.

### CROSS-REFERENCE TO RELATED APPLICATIONS

This application claims priority to Korean Patent Application No. 10-2025-0039432 filed on Mar. 27, 2025, in the Korean Intellectual Property Office, the entire disclosure of which is hereby expressly incorporated by reference into the present application.

### BACKGROUND

### Field

The present disclosure relates to a display device, and more particularly, to a display device applied to a display for a vehicle, for example.

### Discussion of the Related Art

Currently, as our society enters a full-fledged information era, the field of display devices that visually display electrical information signals is rapidly developing, and research is being conducted to improve characteristics such as thickness reduction, weight reduction, and low power consumption for various display devices.

Various types of display devices include a liquid crystal display (LCD), an electro-wetting display (EWD), and an organic light emitting display (OLED).

The liquid crystal display device includes a liquid crystal display panel formed by bonding an upper substrate and a lower substrate with the liquid crystal layer interposed therebetween, a driving circuit for applying a predetermined driving signal to the liquid crystal display panel, and an assembly component for assembling the liquid crystal display panel and the driving circuit, and further includes various components depending on application fields such as a monitor for a computer, a television, or an automobile.

In the related art, a tape attachment method is used to reduce the clearance (gap) between the guide panel and the cover bottom as an assembly component, but there can be a limitation in that it may not sufficiently address the noise problem which can be caused by high-frequency micro-vibration and it may not satisfy the strict noise specifications needed by some customers (e.g., 50 dB or less).

### SUMMARY OF THE DISCLOSURE

An object to be achieved by the present disclosure is to provide a display device capable of satisfying a noise specification by effectively removing a gap between a guide panel and a cover bottom.

Another object to be achieved by the present disclosure is to provide a display device in which a screw-based side fastening method is introduced instead of a tape attachment method to effectively block or minimize foreign substances and moisture that can penetrate between assembly parts.

Objects of the present disclosure are not limited to the above-mentioned objects, and other objects, which are not mentioned above, can be clearly understood by those skilled in the art from the following descriptions.

A display device according to an example embodiment of the present disclosure can include a display panel configured to display an image, a cover glass disposed above the display panel, a cover bottom disposed below the display panel and integrally configured to include a lower portion, a first side portion, and a second side portion disposed inside the first side portion, and a guide panel configured to surround the display panel and the cover bottom under the cover glass and to be laterally fastened to the first side portion of the cover bottom.

A display device according to another example embodiment of the present disclosure can include a display panel configured to display an image, a cover glass disposed above the display panel, a backlight unit disposed below the display panel and including an optical sheet, a cover bottom disposed below the display panel and the backlight unit and integrally configured to include a lower portion, a first side portion, and a second side portion disposed inside the first side portion, and a guide panel configured to surround side surfaces of the display panel and the cover bottom, including a side portion disposed under the cover glass between a side surface of the display panel and the first and second side portions of the cover bottom.

Other detailed matters of the embodiments of the present disclosure are included in the detailed description and the drawings.

According to aspects of the present disclosure, the sidewall of the cover bottom is manufactured in a double partition wall structure by a die casting process, thereby increasing rigidity and reducing or preventing deformation compared to a single structure, and thus having an effect of satisfying customer noise standard.

In addition, according to aspects of the present disclosure, mechanical constraint can prevent or minimize a peel-off problem of the guide panel that can occur during a shock test or a vibration test.

Aspects of the present disclosure adopt a screw-based side fastening method, and has the effect of increasing product reliability by blocking or minimizing the penetration of foreign substances and moisture from the outside through a sealing effect.

Aspects of the present disclosure are designed to mechanically constrain the gap between the guide panel and the cover bottom by forming a hole for screw insertion to the side of the guide panel and applying screw tap machining on the side of the cover bottom, thereby effectively solving or addressing the play or clearance problem that can occur between the assembly parts in the conventional tape attachment method, and reducing material costs and production time by removing the tape.

In addition, according to aspects of the present disclosure, the double partition wall structure of the cover bottom and the screw-based side fastening method are combined to improve the aesthetics of the product.

The effects according to the present disclosure are not limited to the contents exemplified above, and more various effects are included in the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a front view of a display device according to a first embodiment of the present disclosure.

FIG. 2 is a partial perspective view of a display device according to the first embodiment of the present disclosure.

FIG. 3 is an example of a front view of the cover bottom shown in FIG. 2.

FIG. 4 is an example of an enlarged view of part A of FIG. 2.

FIG. 5 is an example of an enlarged perspective view of part B of FIG. 3.

FIG. 6 is an example of an enlarged perspective view of a part of a cover bottom according to an example of the present disclosure.

FIG. 7 is another an example of an enlarged view of part A of FIG. 2.

FIG. 8 is a perspective view illustrating another example of a cover bottom according to the present disclosure.

FIG. 9 is a partial perspective view of a display device according to a second embodiment of the present disclosure.

FIG. 10 is a partial perspective view of a display device according to a third embodiment of the present disclosure.

FIG. 11 is a partial perspective view of a display device according to a fourth embodiment of the present disclosure.

### DETAILED DESCRIPTION OF THE EMBODIMENTS

Advantages and characteristics of the present disclosure and a method of achieving the advantages and characteristics will be clear by referring to example embodiments described below in detail together with the accompanying drawings. However, the present disclosure is not limited to the example embodiments disclosed herein but will be implemented in various forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Further, in the following description of the present disclosure, a detailed explanation of known related technologies can be omitted to avoid unnecessarily obscuring the subject matter of the present disclosure. The terms such as “including,” “having,” and “consist of” used herein are generally intended to allow other components to be added unless the terms are used with the term “only”. Any references to singular can include plural unless expressly stated otherwise.

Components are interpreted to include an ordinary error range even if not expressly stated.

When the position relation between two parts is described using the terms such as “on”, “above”, “below”, and “next”, one or more parts can be positioned between the two parts unless the terms are used with the term “immediately” or “directly”.

When an element or layer is disposed “on” another element or layer, another layer or another element can be interposed directly on the other element or therebetween.

Although the terms such as “first”, “second”, and the like are used for describing various components, these components are not confined by these terms. These terms are merely used for distinguishing one component from the other components. Therefore, a first component to be mentioned below can be a second component in a technical concept of the present disclosure.

Like reference numerals generally denote like elements throughout the disclosure. Further, the term “can” fully encompasses all the meanings and coverages of the term “may” and vice versa.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, various embodiments of the present disclosure will be described in detail with reference to the accompanying drawings. All the components of each display device/apparatus according to all embodiments of the present disclosure are operatively coupled and configured.

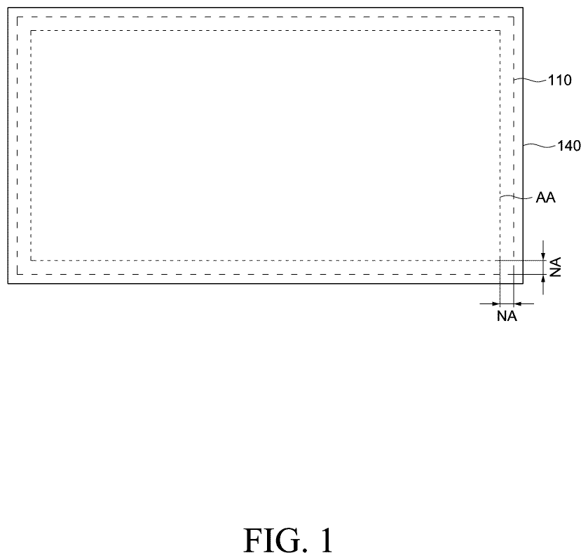

FIG. 1 is a front view of a display device according to a first embodiment of the present disclosure.

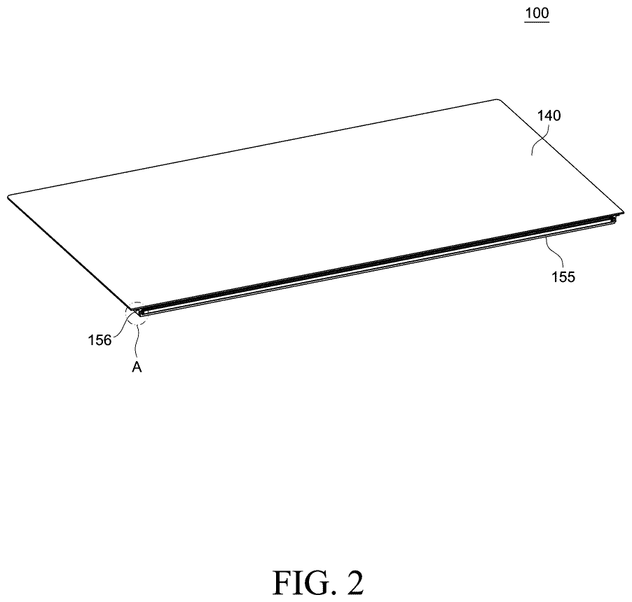

FIG. 2 is a partial perspective view of a display device according to the first embodiment of the present disclosure. Particularly, FIG. 2 illustrates a cross-section of the display device 100 of FIG. 1 taken along a horizontal direction.

Referring to FIGS. 1 and 2, a display device 100 according to the first example embodiment of the present disclosure can include a display panel 110 for displaying an image and a cover part surrounding the outside of the display panel 110.

Such a display device 100 can be used as a display for a vehicle, but is not limited thereto, and can be used in other areas such as a computer monitor, navigation system, gaming device, television, etc. In this case, in order to be used as a stand structure for being provided on the bottom surface of a predetermined space, the display device 100 can further include a stand unit installed under the display panel 110 to support the load of the display panel 110.

Meanwhile, the cover part can include a cover bottom 155 disposed below the display panel 110 and a guide panel 156 disposed on a rear surface and a side surface of the display panel 110 and surrounding the display panel 110 and the side surface of the cover bottom 155.

Further, the cover part can further include a cover glass 140 which is disposed on the top surface of the display panel 110 to be coupled to the horizontal part of the guide panel 156.

However, the display device 100 of the present disclosure is not limited to the configuration of the above-described cover part.

The display panel 110 is a panel for displaying an image to a user. The display panel 110 can include a display area AA (or active area) and a non-display area NA (or non-active area). The display area AA is an area in which images are displayed on the display panel 110.

In the display area AA, a plurality of sub pixels constituting a plurality of pixels and a circuit for driving the plurality of sub pixels can be disposed. The plurality of sub pixels is minimum units constituting the display area AA, and a display element can be disposed in each of the plurality of sub pixels, and the plurality of sub pixels can constitute a pixel. For example, a thin film transistor which is a switching element can be disposed in each of the plurality of sub pixels, but is not limited thereto. Further, a circuit for driving the plurality of sub pixels can include a driving element, a wire, and the like. For example, the circuit can be formed of a thin film transistor, a storage capacitor, a gate line, a data line, or the like, but is not limited thereto. The display element can be defined in different ways depending on the type of the display panel 110, and for example, when the display panel 110 is a liquid crystal display panel, the display panel 110 can include an upper substrate and a lower substrate, and a liquid crystal layer between the upper substrate and the lower substrate.

Hereinafter, the description will be made on the assumption that the display panel 110 is a liquid crystal display panel, but the present disclosure is not limited thereto. For example, when the display panel 110 is an organic light emitting display panel, the display element can be an organic light emitting element including an anode, an organic emission layer, and a cathode.

The non-display area NA is an area where an image is not displayed.

FIG. 1 illustrates that the non-display area NA encloses the display area AA having a rectangular shape. However, the shapes and arrangements of the display area AA and the non-display area NA are not limited to the example illustrated in FIG. 1. For example, the display area AA and the non-display area NA can have shapes suitable for a design of an electronic device including the display device 100. Another example shape of the display area AA can be a pentagon, a hexagon, a circle, an oval, or the like. In another example, the non-display area NA can surround the display area AA entirely or only in some part(s).

Various wires and circuits for driving the liquid crystal display element of the display area AA can be disposed in the non-display area NA. For example, in the non-display area NA, wires for transmitting signals to the plurality of sub pixels and circuits of the display area AA or a driving integrated circuit (IC) such as a gate driver IC and a data driver IC can be disposed, but it is not limited thereto.

The display panel 110 can include various additional elements for generating various signals or driving the pixel in the display area AA. The additional elements for driving the pixels can include an inverter circuit, a multiplexer, an electrostatic discharge (ESD) circuit, and the like. The display panel 110 can also include additional elements related to functions other than pixel driving. For example, the display panel 110 can include additional elements that provide a touch sensing function, a user authentication function (e.g., fingerprint recognition), a multi-level pressure sensing function, a tactile feedback function, and the like. The additional elements can be located in an external circuit connected to the non-display area NA and/or the connection interface.

As described above, the display panel 110 can include an upper substrate and a lower substrate, and a liquid crystal layer interposed between the upper substrate and the lower substrate. The liquid crystal display device is a flat panel display device that displays an image by adjusting a transmittance of light according to an arrangement of liquid crystal molecules of the liquid crystal layer when light is transmitted.

To this end, a backlight unit for supplying light and a cover bottom 155 for accommodating the backlight unit and the display panel 110 can be disposed below the display panel 110. The backlight unit can include a light source and an optical means for supplying light generated from the light source to the display panel 110.

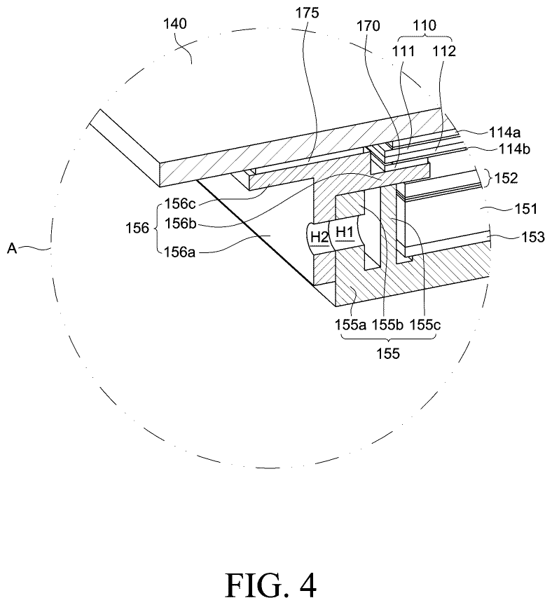

Some configurations of the cover bottom 155 and the backlight unit can be fixed by the guide panel 156 disposed below the display panel 110. The display panel 110 will be described in more detail below with reference to FIG. 4.

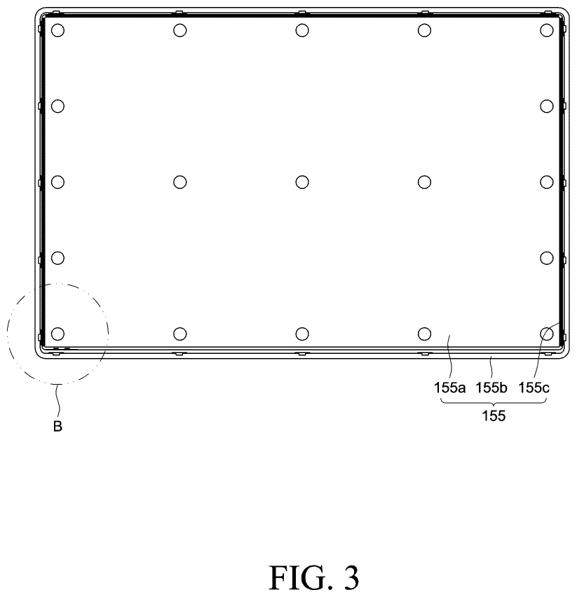

Meanwhile, in the first embodiment of the present disclosure, the sidewall of the cover bottom 155 is manufactured in a double partition wall structure by a die casting process, thereby increasing rigidity and reducing deformation compared to a single structure. In addition, by adopting the screw-based side fastening method, foreign substances and moisture penetrating from the outside are blocked through the sealing effect, which will be described in detail with reference to FIGS. 3 to 6.

FIG. 3 is a front view of the cover bottom shown in FIG. 2.

The cover bottom 155 of the first example embodiment of the present disclosure can accommodate a display panel and a backlight unit.

Referring to FIG. 3, for this purpose, the cover bottom 155 according to the first embodiment of the present disclosure can include a lower portion 155a configured to support a backlight unit and side portions 155b and 155c extending in a direction perpendicular to an edge of the lower portion 155a.

In this case, the side portions 155b and 155c of the cover bottom 155 can vertically and integrally extend from the lower portion 155a so that the backlight unit is accommodated.

In the cover bottom 155 of the first embodiment of the present disclosure, side portions 155b and 155c vertically formed to increase rigidity and reduce deformation can have a double partition wall structure.

The side portions 155b and 155c can have a double partition wall structure including a first side portion 155b fastened to the guide panel and a second side portion 155c positioned inside the first side portion 155b and configured to accommodate the backlight unit.

An empty space can be formed between the first side portion 155b and the second side portion 155c.

The cover bottom 155 according to the first embodiment of the present disclosure can integrally form the lower portion 155a and the side portions 155b and 155c using a method such as die casting. In addition, the cover bottom 155 can be formed of a metal material, but is not limited thereto, and can be formed of a plastic material for weight reduction.

In the case of a metal material, the cover bottom 155 can be made of aluminum, zinc, magnesium, tin, or an alloy thereof.

For example, the cover bottom 155 can be made of a magnesium alloy.

For reference, magnesium, which is the main component of the magnesium alloy, has a density of approximately 1.74, which corresponds to ⅔ of the aluminum alloy, ⅓ of the titanium alloy, and ¼ of the iron, which is the lightest material among commercial metal materials.

Further, magnesium alloy has excellent specific strength, and specific strength is a value obtained by dividing the strength of the material by the specific weight, and the higher this value, the higher the strength.

In addition, the magnesium alloy has excellent vibration damping ability, is excellent in dimensional stability of the product due to less change in dimensions caused by temperature or other surrounding environments, and is excellent in weldability, machinability, electromagnetic wave shielding, and heat dissipation.

As such, the magnesium alloy has the advantages of high strength and vibration absorption, as well as being lightweight, being energy efficient in machining, blocking electromagnetic waves, and effectively dissipating heat.

Accordingly, the cover bottom 155 made of the above-described magnesium alloy not only supplements the strength of the cover bottom conventionally made of stainless steel, but also absorbs an external impact to protect the display panel and shields electromagnetic interference generated in the display device to implement a reliable and eco-friendly display device.

The cover bottom 155 made of such a metal material can be manufactured by a die casting process.

At this time, the die casting process, also referred to as die casting, is a precision casting method in which molten metal is injected into a mold corresponding to a casting shape to obtain a casting identical to the mold. A die-cast product manufactured by the die casting process is characterized by accurate dimensions, excellent mechanical properties, and possible mass production.

In particular, when the die casting process is used, the thickness can be adjusted unlike press processing.

FIG. 4 is an enlarged view of part A of FIG. 2 according to an example of the present disclosure.

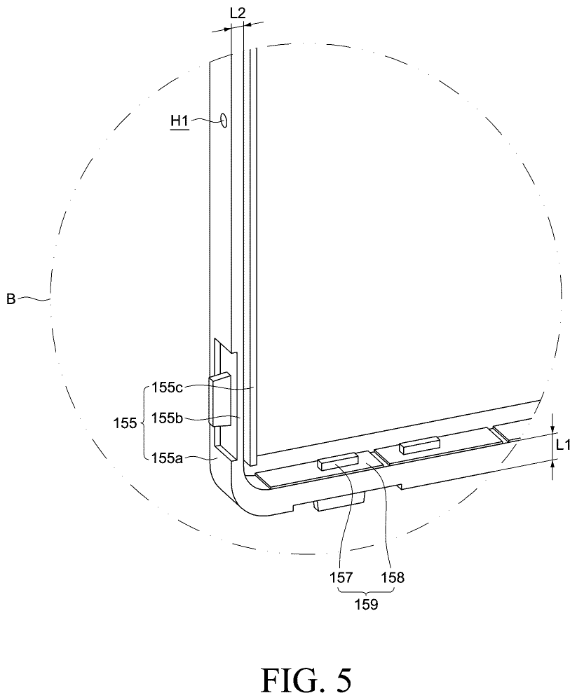

FIG. 5 is an enlarged perspective view of part B of FIG. 3 according to an example of the present disclosure.

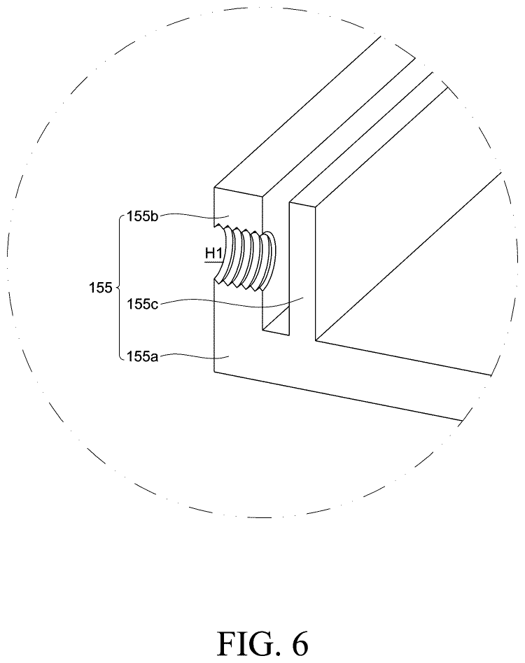

FIG. 6 is an enlarged perspective view of a part of a cover bottom according to an example of the present disclosure.

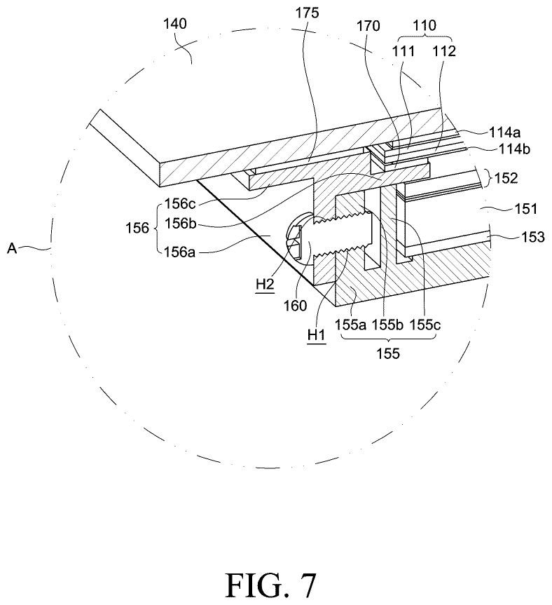

FIG. 7 is another enlarged view of part A of FIG. 2 according to an example of the present disclosure.

Particularly, FIG. 4 is a perspective view illustrating a part of a display device according to the first embodiment of the present disclosure before the screw 160 is laterally fastened, and FIG. 7 is a perspective view illustrating a part of the display device according to the first embodiment of the present disclosure in which the screw 160 is laterally fastened.

FIG. 5 is an enlarged view of a part of the left and lower sides of the cover bottom 155 of FIG. 3. FIG. 6 is an enlarged view of a part of the cover bottom 155 illustrated in FIG. 4.

Referring to FIGS. 4 to 7, the display device according to the first embodiment of the present disclosure can include a display panel 110 for displaying an image, a cover bottom 155 disposed below the display panel 110, a guide panel 156 disposed on a rear surface and a side surface of the display panel 110 and configured to surround the display panel 110 and the side surface of the cover bottom 155, and a backlight unit accommodated in the cover bottom 155.

First, the display panel 110 can include upper and lower substrates 111 and 112 and a liquid crystal layer interposed between the upper and lower substrates 111 and 112.

Hereinafter, the description will be made on the assumption that the display panel 110 is a liquid crystal display panel, but the present disclosure is not limited thereto as described above. When the display panel 110 is an organic light emitting display panel, the display element can be an organic light emitting element including an anode, an organic emission layer, and a cathode.

For example, under the premise of an active matrix method, a plurality of gate lines and data lines cross each other on an inner surface of a lower substrate 112, commonly referred to as an array substrate or a first substrate, to define a sub pixel, and a thin film transistor is provided at each intersection to be connected to a pixel electrode formed in each sub pixel.

In addition, a color filter of red R, green G, and blue B corresponding to each sub pixel, and a black matrix covering non-display elements such as gate lines, data lines, and thin film transistors, are provided on the inner surface of the upper substrate 111 called the color filter substrate or a second substrate. In this case, when the liquid crystal display panel is in an in-plane switching (IPS) mode or a fringe field switching (FFS) mode, the common electrode can be formed over the lower substrate 112.

Further, the upper and lower polarizers 114a and 114b selectively transmitting only specific light can be attached to outer surfaces of the upper and lower substrates 111 and 112, respectively.

Meanwhile, the display device can further include a flexible film and a source printed circuit board.

First, the flexible film is a film in which various components are disposed on a base film having ductility. For example, the flexible film is a film for supplying signals to the plurality of sub pixels and circuits of the display area (AA in FIG. 1) and can be electrically connected to the display panel 110. The flexible film is disposed at one end of the non-display area (NA in FIG. 1) of the display panel 110 to supply a power voltage, a data voltage, and the like to the plurality of sub pixels and the circuit of the display area AA. Meanwhile, the number of flexible films can be variously changed according to design, but is not limited thereto.

For example, a driving IC such as a data driver IC can be disposed on the flexible film. The driving IC is a component that processes a data signal for displaying an image and a driving signal for processing the data signal. The driving IC can be disposed by a chip on glass (COG), a chip on film (COF), a tape carrier package (TCP) method, or the like depending on a mounting method.

Further, the source printed circuit board can be disposed at one end of the flexible film to be connected to the flexible film. The source printed circuit board is a component that supplies signals to the driving IC. The source printed circuit board can supply various signals such as a driving signal and a data signal to the driving IC. For example, a data driver for generating data signals can be mounted on the source printed circuit board, and the generated data signal can be supplied to the plurality of sub pixels and circuits of the display panel 110 through the flexible film. The number of source printed circuit boards can vary depending on the design, but is not limited thereto.

Meanwhile, a backlight unit for supplying light and a cover bottom 155 and a guide panel 156 for accommodating the backlight unit and the display panel 110 can be disposed below the display panel 110 configured as described above.

The backlight unit can include an LED (light emitting diode) array assembly 159 including a light source accommodated in the cover bottom 155, a light guide plate 151 which supplies a surface light source to the display panel 110 through the light source, a reflection plate 153 disposed on the rear surface of the light guide plate 151, and a plurality of optical sheets 152 disposed on the upper surface of the light guide plate 151, but is not limited thereto.

The backlight unit can further include a side reflection plate disposed on a side surface of the light guide plate 151 except for a lower side of the display device on which the LED array assembly 159 is disposed, but is not limited thereto.

In the meantime, the light traveling to the light incident surface of the light guide plate 151 passes through a total reflection process several times inside the light guide plate 151 to be emitted toward the upper direction in which the display panel 110 is disposed. In this case, the light guide plate 151 can include a pattern having a specific shape on the rear surface to supply a uniform surface light source. The pattern can be configured in various ways, such as an elliptical pattern, a polygonal pattern, a holographic pattern, etc. to guide light incident into the light guide plate 151. The pattern can be formed on a lower surface of the light guide plate 151 by a printing method or an injection method.

The optical sheet 152 can include at least one of a lower diffusion sheet, a lower prism sheet, an upper prism sheet, an upper diffusion sheet, and a prism sheet.

For example, the light source can be configured by an LED package 157 on which LEDs are mounted, and can be disposed in an area of the light incident surface of the light guide plate 151. Further, the LED array assembly 159 can include an LED package 157 and an LED printed circuit board 158.

The cover bottom 155 according to the first embodiment of the present disclosure can accommodate the display panel 110 and the backlight unit. To this end, the cover bottom 155 according to the first embodiment of the present disclosure can include a lower portion 155a supporting the backlight unit and side portions 155b and 155c extending in a direction perpendicular to the edge of the lower portion 155a.

For example, the lower portion 155a of the cover bottom 155 can have a rectangular shape according to the shape of the display panel 110, but is not limited thereto.

In addition, as described above, the side portions 155b and 155c of the cover bottom 155 can vertically extend from the lower portion 155a so that the backlight unit is accommodated. For example, the side portions 155b and 155c of the cover bottom 155 can vertically extend from an edge of the lower portion 155a toward the display panel 110.

In addition, the cover bottom 155 of the first embodiment of the present disclosure can have a double partition wall structure. To this end, for example, the side portions 155b and 155c of the cover bottom 155 can include a first side portion 155b which is located at the outside relatively and is fastened to the side portion 156a of the guide panel 156, and a second side portion 155c which is located inside the first side portion 155b and accommodates the backlight unit.

The first embodiment of the present disclosure of FIGS. 4 to 7 illustrates an example in which the LED array assembly 159 has a double partition wall structure on the upper, left, and right sides of the display device on which the LED array assembly 159 is disposed. However, the present disclosure is not limited thereto. The display device can have a double partition wall structure on all the upper, lower, left, and right sides, and can have a double partition wall structure on at least one side of the upper, lower, left, and right sides.

For example, the first side portion 155b can vertically extend upward from an edge of the lower portion 155a. Further, for example, the second side portion 155c can extend vertically from the inside of the first side portion 155b in an upward direction from a part of the lower portion 155a.

For example, the first side portion 155b and the second side portion 155c can have the same height, but are not limited thereto, and can have different heights.

In addition, the first side portion 155b and the second side portion 155c can have the same thickness, but are not limited thereto, and can have different thicknesses.

In the present disclosure, the sidewall of the cover bottom 155 is manufactured with a double partition wall structure to increase rigidity and reduce deformation compared to a single structure, thereby having the effect of satisfying the noise standard required by the customer.

For example, in the case of a display product mounted on a vehicle, it is an important task to improve the rattle noise generated by the vibration of the vehicle.

To this end, the clearance (gap) generated during assembly between the guide panel and the cover bottom in the backlight unit is minimized to prevent noise caused by vibration.

In a related art, a single side tape is attached from the side of the guide panel to the rear surface of the cover bottom to reduce clearance between assembly parts, and a double side tape is additionally applied to supplement the fixation. However, as the noise specifications of electric vehicles have recently been further strengthened, there have been cases in which the conventional tape attachment method alone does not satisfy the customer demand standard.

On the other hand, in the case of the present disclosure, the sidewall of the cover bottom 155 is designed as a double partition wall structure to improve the rigidity compared to the conventional single structure and minimize the deformation, thereby effectively reducing the clearance generated during assembly. In particular, the double partition wall structure and the screw-based side fastening method described later increase the fastening strength with the guide panel 156 to suppress the flow between components and minimize even a minute gap change due to vibration, thereby effectively reducing vibration noise in a high frequency area.

In addition, in a conventional method, due to the problem of assembly productivity, the tape had to be attached only to some sections of the guide panel and the cover bottom.

However, the structure of the present disclosure is designed to realize the same effect while minimizing the use of the tape. Accordingly, the double partition wall structure according to the present disclosure improves rigidity and durability while simplifying the assembly process, thereby providing an advantageous effect in meeting the noise standard of a vehicle display including an electric vehicle.

Meanwhile, the cover bottom 155 according to the first embodiment of the present disclosure can integrally form the lower portion 155a and the side portions 155b and 155c using a method such as die casting.

For example, the first side portion 155b can extend vertically and integrally from the edge of the lower portion 155a in the upward direction, and the second side portion 155c can extend vertically and integrally from the inside of the first side portion 155b in the upward direction from a part of the lower portion 155a.

In addition, the cover bottom 155 can be formed of a metal material, but the present disclosure is not limited thereto, and can be formed of a plastic material for weight reduction.

When using the die casting process, the thickness can be adjusted unlike press processing.

For example, an upper side, a left side, and a right side of the display device can have a double partition wall structure including a first side portion 155b and a second side portion 155c. Further, a lower side of the display device can have a single partition structure including one first side portion 155b.

In this case, a first side portion 155b of the lower cover bottom 155 can have a first thickness L1, and a first side portion 155b of the left cover bottom 155 can have a second thickness L2 which is thinner than the first thickness. This is to supplement the rigidity by designing the thickness of the first side portion 155b of the lower cover bottom 155 having a single partition wall structure to be thicker than those of the upper, left, and right side portions 155b having a double partition wall structure.

For example, the thickness of each component of the cover bottom 155 can be formed differently through the die casting process.

Further, in the case of the first embodiment of the present disclosure, the lower portion 155a and the first side portion 155b of the cover bottom 155 are integrally formed through the die casting process so that the connection portion can be rounded to be formed more smoothly. Further, not only the lower portion 155a and the first side portion 155b of the cover bottom 155 but also the second side portion 155c can be integrally formed through the die casting process.

If it is formed in a vertical bending manner through press processing, it is difficult to smoothly process the lower portion and the bent portion of the side portion of the cover bottom, and the second side portion described above cannot also be formed.

As described above, the present disclosure has an effect of improving rigidity and reducing deformation compared to a conventional single structure by manufacturing the sidewall of the cover bottom 155 into a double partition wall structure of the first side portion 155b and the second side portion 155c.

In particular, by applying the die casting process to integrally form the lower portion 155a, the first side portion 155b, and the second side portion 155c of the cover bottom 155, it is possible to increase the strength of the connection portion and prevent a coupling failure that can occur during assembly.

This structural reinforcement can contribute to improving durability against external impacts and vibrations that can occur in a use environment of the display device. For example, it is possible to suppress a peeling-off problem of the guide panel 156 that can occur during a shock test or a vibration test, thereby increasing reliability.

In addition, by applying the double partition wall structure to supplement the rigidity of the cover bottom 155, deformation can be minimized and a noise blocking effect can be improved. In other words, it is designed to meet the noise standards required by customers, thereby providing the effect of simultaneously improving the durability and usability of the product.

Furthermore, since the thickness of each part can be optimized by utilizing a die casting process, a part requiring rigidity (e.g., a lower side having a single partition wall structure) can be made thick, and a part requiring weight reduction (e.g., an upper side, a left side, and a right side) can be designed to be relatively thin. Accordingly, strength can be reinforced without unnecessary weight increase, and assembly consistency can be improved by increasing precision in the manufacturing process.

As a result, the present disclosure provides effects such as increased rigidity, preventing deformation, meeting noise criteria, enhancing shock and vibration durability, and lightening through optimized thickness design, thereby increasing product reliability and meeting customer needs.

Meanwhile, some components of the backlight unit can be fixed by the guide panel 156 and the guide panel 156 can surround and fix side surfaces of the display panel 110 and the cover bottom 155.

Further, a cover glass 140 can be coupled to the horizontal portion of the guide panel 156 on the top surface of the display panel 110.

For example, the cover glass 140 can include a lower coating layer, a glass layer which is a layer on the lower coating layer, and an upper coating layer which is an upper layer of the glass layer, but is not limited thereto.

The lower coating layer is used for improving the visibility of image light emitted from the display panel 110 disposed therebelow. Therefore, the lower coating layer can be formed of a transparent material. Further, the lower coating layer is used for planarizing the flat surface of the display device. Accordingly, the lower coating layer can be formed over the entire surface of the display panel 110. Further, the lower coating layer can be formed of a flexible material. The lower coating layer can include an adhesive component.

The glass layer can include glass as an upper layer of the lower coating layer.

The upper coating layer is a layer interposed on the glass layer and can be formed of a soft material or a strong material. The upper coating layer is coated on the entire surface of the display panel 110 to improve the hardness of the cover glass 140.

The lower coating layer and the upper coating layer can have a transmittance of 80% or more, a reflectance of 20% or less, a refractive index of 1.45 to 1.55, and an elongation rate of 30% or more. For example, it can be a silicon, acrylic, epoxy, or urethane-based material.

An upper film can be interposed on the upper layer of the upper coating layer. Such an upper film can be interposed in the upper layer of the upper coating layer in order to supplement visibility or reinforce rigidity.

The cover glass 140 configured as described above can have a shape protruding outward from the display panel 110 to enhance design completeness by preventing lower components from being directly visible from the outside, and to stably couple with the guide panel 156. Accordingly, the cover glass 140 can keep the appearance of the display device cleaner, and can serve to improve durability and reliability by improving precision during assembly.

The guide panel 156 can be formed in a rectangular frame shape such that its cross section has a T-shaped structure.

For example, the guide panel 156 according to the first embodiment of the present disclosure can include a side portion 156a disposed on a side surface of the display panel 110 and the cover bottom 155 to surround the side surface of the display panel 110 and the cover bottom 155. Further, the guide panel 156 can include a first horizontal portion 156b which extends from the side portion 156a between the display panel 110 and the optical sheet 152 to fix the optical sheet 152 and a second horizontal portion 156c which extends outward from the side portion 156a to support the rear edge of the cover glass 140.

In this case, the side portion 156a of the guide panel 156 can protrude in a direction perpendicular to the first horizontal portion 156b to surround the side surface of the display panel 110.

For example, a rear edge of the display panel 110 can be seated on the first horizontal portion 156b of the guide panel 156. Further, the display panel 110 can be attached to the first horizontal portion 156b of the guide panel 156 through a first adhesive member 170 such as an adhesive tape or a foam pad. However, the present disclosure is not limited thereto, and the adhesive tape or foam pad can be omitted.

The adhesive tape or foam pad can have a frame shape along left, right, and upper edges excluding the lower side of the display panel 110, but is not limited thereto.

For example, a rear edge of the cover glass 140 can be seated on the second horizontal portion 156c of the guide panel 156. Further, the cover glass 140 can be attached to the second horizontal portion 156c of the guide panel 156 through a second adhesive member 175 such as an adhesive tape or a foam pad. However, the present disclosure is not limited thereto, and the adhesive tape or foam pad can be omitted.

To fasten the cover bottom 155 and the guide panel 156, screw holes H1 and H2 can be formed in the two parts, respectively. For example, a first screw hole H1 can be formed in the first side portion 155b of the cover bottom 155, and a second screw hole H2 can be formed in the side portion 156a of the guide panel 156 at a position corresponding thereto.

The first and second screw holes H1 and H2 provide a path through which the screw 160 is inserted to couple the two components, and can be designed to smoothly fasten the screw 160. The first and second screw holes H1 and H2 of the cover bottom 155 and the guide panel 156 are accurately positioned on the side of each component, and holes are drilled in an appropriate size and shape suitable for this position.

The first and second screw holes H1 and H2 can perform two main functions. First, the screw 160 is inserted to provide a path for coupling the two parts. Second, the sizes and shapes of the first and second screw holes H1 and H2 should be designed to allow the screw 160 to exhibit an appropriate fastening force. For example, the sizes and positions of the first and second screw holes H1 and H2 need to be exactly fitted with the screw threads of the screw 160. For example, when an excessively large hole is formed, the fastening force can be weakened or a gap between parts can occur. On the other hand, if the hole is too small, the screw 160 may not enter properly or the screw thread can be damaged.

The process of forming the first and second screw holes H1 and H2 can vary depending on the material, size, and coupling method of the cover bottom 155 and the guide panel 156. It can be designed to make a hole in the side portion of the cover bottom 155 and the guide panel 156 and insert a screw 160 suitable for the hole. In this case, accurate positions of the first and second screw holes H1 and H2 are very important. If the position is incorrect, the screw 160 may not properly fasten the parts, thereby weakening the coupling strength and reducing the stability of the product.

There are various methods of processing for forming the first and second screw holes H1 and H2. In general, the hole can be formed by a drilling method, and a high-precision tool capable of accurately drilling a hole suitable for the required size and depth can be used. Thereafter, the screw thread can be processed in the first and second screw holes H1 and H2 through a method (e.g., tapping) of forming the screw thread in the hole. In this process, the screw 160 is smoothly fastened by processing the threads to exactly match.

In addition, the screw thread for fastening between the cover bottom 155 and the guide panel 156 can be mainly formed in two ways. The first method is a screwing processing method (tapping method), which is a method of directly forming a thread on the side portions of the cover bottom 155 and the guide panel 156. In this process, a hole having a size suitable for the side surface of each component can be drilled, and when the screw 160 is fastened, the thread can be processed in the hole in parallel. In the screw processing method, a screw 160 is inserted into a hole while forming a thread so that a thread of a suitable shape and size is formed so that the screw 160 can be accurately inserted.

At this time, in the screwing processing method, when the two parts, for example, the cover bottom 155 and the guide panel 156, are coupled, they are accurately engaged with the thread of the screw 160 so that the two parts are firmly coupled. The side portion on which the screw thread is formed accurately matches the screw 160 to increase the fastening force, and when assembled, the screw 160 can be rotated to complete the coupling according to the screw thread. The screwing processing method is particularly effective when the coupling between parts is important, and is very effective in preventing separation due to vibration and ensuring stable coupling.

The second is the screw insertion method. This method uses an insert with already formed threads to provide threads after insertion into a hole. For example, the insert is made of metal or synthetic material, so it is durable and has strong properties against repeated fastening. When an insert is used, a thread can be formed by drilling a hole and then inserting it, so that a more durable thread can be formed compared to a screw processing method.

As a result, both the screw processing method and the screw insertion method play an important role in strengthening the coupling between the two parts, preventing separation due to vibration or external impact, and increasing the stability of the product.

In addition, it is possible to apply a cutting process that directly makes a thread in the hole.

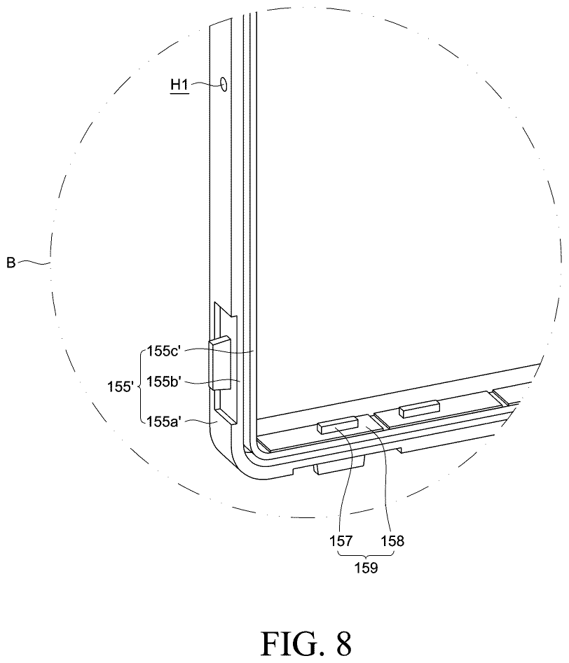

Meanwhile, in the display device of the present disclosure, a double partition wall structure can be applied to the cover bottom on all sides, including the lower side, and a specific example thereof will be described in detail with reference to FIG. 8.

FIG. 8 is a perspective view illustrating another example of a cover bottom according to an example of the present disclosure.

Referring to FIG. 8, another cover bottom 155′ according to the first embodiment of the present disclosure can include a lower portion 155a′ supporting a backlight unit and side portions 155b′ and 155c′ extending in a direction perpendicular to an edge of the lower portion 155a′.

As described above, the side portions 155b′ and 155c′ of the cover bottom 155′ can vertically extend from the lower portion 155a′ to accommodate the backlight unit.

Another cover bottom 155′ according to the first embodiment of the present disclosure can have a double partition wall structure on all sides (up, down, left and right sides) including the lower side of the display device. To this end, for example, the side portions 155b′ and 155c′ of the cover bottom 155′ are located relatively outside and can include a first side portion 155b′ fastened to the side portion of the guide panel and a second side portion 155c′ located inside the first side portion 155b′ to accommodate the backlight unit. For example, the first side portion 155b′ can vertically extend from the edge of the lower portion 155a′ in an upward direction. Further, for example, the second side portion 155b′ can extend vertically from the upper side of the first side portion 155a′.

Another cover bottom 155′ according to the first embodiment of the present disclosure has an effect of increasing rigidity and reducing deformation than a single structure by manufacturing all sides in a double partition wall structure, thereby satisfying a noise standard required by a customer.

For example, the first side portion 155b′ and the second side portion 155c′ can have the same height, but are not limited thereto and can have different heights. Further, the first side portion 155b′ and the second side portion 155c′ can have the same thickness, but are not limited thereto and can have different thicknesses.

Meanwhile, another cover bottom 155′ according to the first embodiment of the present disclosure can be integrally formed with the lower portion 155a′ and the side portions 155b′ and 155c′ using a method such as die casting. For example, the first side portion 155b′ can vertically and integrally extend from an edge of the lower portion 155a′ in an upward direction, and the second side portion 155c′ can vertically and integrally extend from the inside of the first side portion 155b′ in an upward direction from a part of the lower portion 155a′.

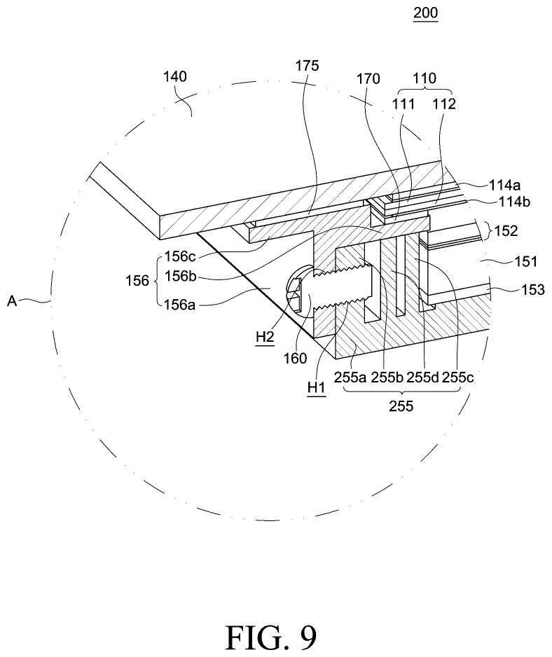

Meanwhile, according to the present disclosure, a triple or more partition wall structure can be applied to the cover bottom, and a specific example thereof will be described in detail with reference to FIG. 9.

FIG. 9 is a partial perspective view of a display device according to a second embodiment of the present disclosure.

The second embodiment of the present disclosure shown in FIG. 9 is substantially the same as the first embodiment shown in FIG. 1 through FIG. 8 except that a triple partition wall structure is applied to the cover bottom. Therefore, redundant description thereof will be omitted. The same components will be denoted by the same reference numerals. Hereinafter, description of the same reference numerals can refer to FIGS. 1 to 8.

Referring to FIG. 9, the cover bottom 255 of the display device 200 according to the second example embodiment of the present disclosure can include a lower portion 255a and first and second side portions 255b and 255c extending in a direction perpendicular to an edge of the lower portion 255a.

The first side portion 255b is positioned at an outer side of the cover bottom 255 and is fastened to the side portion 156a of the guide panel 156. The second side portion 255c is positioned at an inner side of the first side portion 255b to accommodate the backlight unit.

In addition, the cover bottom 255 according to the second example embodiment of the present disclosure is characterized in that it adopts a triple partition wall structure additionally including third side portions 255d in addition to the lower portion 255a and the first and second side portions 255b and 255c.

The triple partition wall structure plays an important role in maximizing the rigidity and minimizing deformation of the cover bottom 255. By applying the triple partition wall structure, the cover bottom 255 becomes much more robust than the single partition wall structure or the double partition wall structure, and durability against external impact or pressure can be significantly improved.

For example, the lower portion 255a is formed in a rectangular shape according to the shape of the display panel 110 and serves to stably support the backlight unit. The first side portion 255b extending from the lower portion 255a is fastened to the side portion 156a of the guide panel 156 through the screw 160, and the second side portion 255c is located inside the third side portion 255d to provide a space for accommodating the backlight unit. These first and second side portions 255b and 255c are integrally formed with the lower portion 255a to add structural strength.

The third side portion 255d is additionally formed between the first side portion 255b and the second side portion 255c to further increase the overall rigidity and prevent warpage or deformation of the cover bottom 255. The third side portion 255d serves to combine the first side portion 255b and the second side portion 255c to increase the stability of the overall structure. In particular, the third side portion 255d serves to disperse the impact in the external environment and protect the internal components, thereby extending the lifetime of the display device.

By adopting the triple partition wall structure as described above, the cover bottom 255 can have more excellent durability and high strength. This structure provides essential durability for an electronic device, and is particularly effective in minimizing deformations caused by vibrations, shocks, and external pressures occurring in a high-speed machine or electronic device. In addition, vibration can be efficiently absorbed, allowing the device to be operated in a more stable and quiet environment. This structure is particularly useful in various high-speed and high-vibration environments such as high-speed railways, electronic devices, and electric vehicles.

In addition, the triple partition wall structure can be integrally manufactured through a die casting method or an extrusion molding method. Through this manufacturing method, the lower portion 255a, the first side portion 255b, the second side portion 255c, and the third side portion 255d can be formed in one continuous structure, which can simplify the assembly process and reduce production costs. In addition, due to the integrated structure, the coupling between parts is more robust, and errors that can occur during additional assembly processes can be prevented.

In addition, the triple partition wall structure plays an important role in not only noise blocking but also heat dissipation. The multilayer structure of the cover bottom 255 serves to efficiently dissipate heat generated from the internal components to the outside, which can prevent overheating of the device and ensure stable operation. In particular, it is effective in protecting components generating high heat, such as backlight units, and can solve thermal problems that can occur in high-speed machines or electronic devices.

As a result, the second embodiment of the present disclosure provides much more improved strength, durability, and noise blocking performance through the triple partition wall structure compared to the single partition structure or double partition wall structure, and exhibits stable performance in various environments such as high-speed driving and electronic device.

However, the present disclosure is not limited to the above-described triple partition wall structure, and can be applied to the four or more partition wall structure as necessary. Accordingly, the structural strength can be further improved, and durability and stability of the display device can be maximized in various environments.

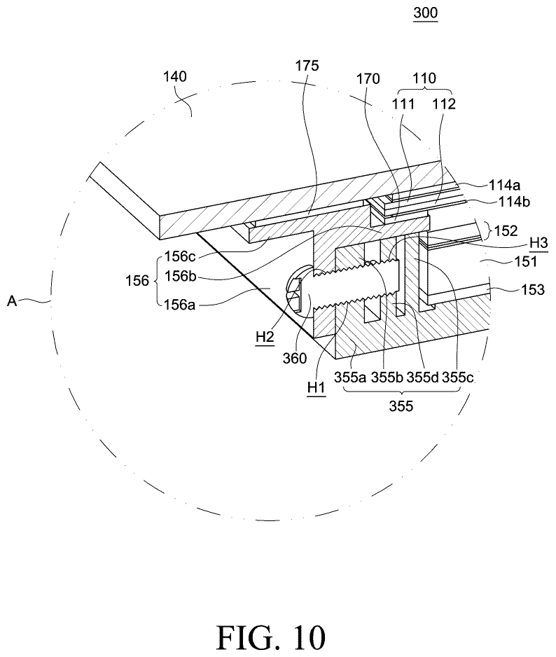

Meanwhile, in the above-described triple partition wall structure, a screw hole can be formed in a third side portion in addition to the first side portion of the cover bottom to fasten the screw to the screw hole of the third side portion, and a specific example thereof will be described in detail with reference to FIG. 10.

FIG. 10 is a partial perspective view of a display device according to a third embodiment of the present disclosure.

The third embodiment of the present disclosure of FIG. 10 is different from the second embodiment of FIG. 9 described above only in that a screw hole is formed in a third side portion in addition to the first side portion of the cover bottom, and the screw is fastened to the screw hole of the third side portion, and other configurations are substantially the same, so that a redundant description will be omitted. The same components will be denoted by the same reference numerals. Hereinafter, description of the same reference numerals can refer to FIGS. 1 to 9.

Referring to FIG. 10, the display device 300 of the third embodiment of the present disclosure forms the third screw hole H3 in the third side portion 355d of the cover bottom 355 compared to the second embodiment described above, such that the screw 360 is fastened to the third screw hole H3 of the third side portion 355d. This method plays an important role in further enhancing the durability and strength of the display device 300 and can be applied more effectively, particularly in special applications such as vehicle displays including electric vehicles.

In the third example embodiment of the present disclosure, the first and third screw holes H1 and H3 are formed in the cover bottom 355 to fasten the screws 360 to the first and third side portions 355a and 355d to increase the strength of the display device 300.

To this end, a first screw hole H1 can be formed in the first side portion 355b of the cover bottom 355 and a second screw hole H2 can be formed in the side portion 156a of the guide panel 156. Further, a third screw hole H3 is formed in the third side portion 355d of the cover bottom 355 to fasten the screws 360 to the first, second, and third screw holes H1, H2, and H3. This screw fastening method makes the coupling of the first and third side portions 355b and 355d of the cover bottom 355 and the side portion 156a of the guide panel 156 more robust, thereby greatly improving the strength and stability of the entire cover bottom 355.

In this way, the first screw hole H1 is formed in the first side portion 355b of the cover bottom 355 to fix the cover bottom 355 and the guide panel 156. The second screw hole H2 is formed in the side portion 156a of the guide panel 156 to fix the guide panel 156 to the cover bottom 355. The third screw hole H3 is formed in the third side portion 155d of the cover bottom 355 and is fastened to the third side portion 155d of the cover bottom 355 with a screw 360 to further enhance the overall strength of the display device 300.

This double and triple screw fastening method plays an important role in accurately fixing each part of the cover bottom 355 and improving the durability of the display device 300. In addition, the double and triple screw fastening method can be effectively applied to displays with special requirements strong against high temperature, vibration, and impact, such as electric vehicle displays.

The triple partition wall structure and screw fastening method according to the third embodiment of the present disclosure are very useful in a special display device field such as an electric vehicle display. The electric vehicle display is mainly installed inside and outside the vehicle to perform various functions, and high durability and stability are required. In particular, in order for the display device to operate safely in a vibration, high temperature, and high speed driving environment of an electric vehicle, strong durability and precise fixing are required.

The present disclosure is not limited to the above-described triple partition wall structure and screw fastening method, and if necessary, a quadruple or more partition wall structure can be applied. In addition, the screw fastening method can also be modified by forming an additional screw hole or adjusting the fastening position according to various design requirements. Accordingly, rigidity and assembly stability of the display device can be further improved, and reliability can be maximized even in a high vibration environment such as a display for an electric vehicle.

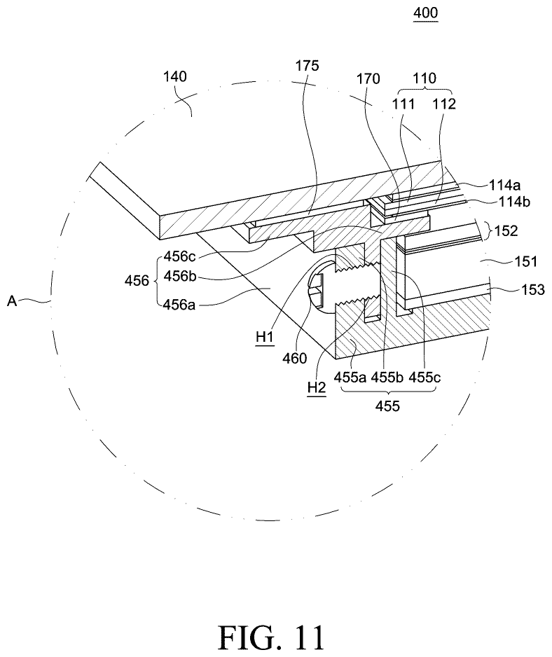

Meanwhile, according to the present disclosure, a side portion of the guide panel can be inserted and fixed between the first side portion and the second side portion of the cover bottom, and a specific example thereof will be described in detail with reference to FIG. 11.

FIG. 11 is a partial perspective view of a display device according to a fourth embodiment of the present disclosure.

The fourth embodiment of the present disclosure shown in FIG. 11 is substantially the same as the first embodiment shown in FIG. 1 through FIG. 8 except that a side portion of the guide panel is inserted and fixed between the first side portion and the second side portion of the cover bottom. Therefore, redundant description thereof will be omitted or may be briefly provided. The same components will be denoted by the same reference numerals. Hereinafter, description of the same reference numerals can refer to FIG. 1 through FIG. 10.

Referring to FIG. 11, the display device 400 according to the fourth embodiment of the present disclosure can include a display panel 110 for displaying an image, a cover bottom 455 disposed below the display panel 110, a guide panel 456 disposed on a rear surface and a side surface of the display panel 110 and surrounding the side surface of the display panel 110 and the cover bottom 455, and a backlight unit accommodated in the cover bottom 455.

According to the fourth embodiment of the present disclosure, the side portion 456a of the guide panel 456 is inserted and fixed between the first side portion 455b and the second side portion 455c of the cover bottom 455. Accordingly, the coupling strength between the display panel 110, the cover bottom 455, and the guide panel 456 is strengthened, and structural stability is improved.

The cover bottom 455 can include a lower portion 455a supporting the backlight unit, and a first side portion 455b and a second side portion 455c extending in a direction perpendicular to the lower portion 455a.

For example, the first side portion 455b can vertically extend upward from an edge of the lower portion 455a. Further, for example, the second side portion 455c can vertically extend upward from a part of the lower portion 455a inside the first side portion 455b.

In this case, the side portion 456a of the guide panel 456 can be fastened between the first side portion 455b and the second side portion 456c of the cover bottom 455. For example, the guide panel 456 according to the fourth example embodiment of the present disclosure can include a side surface of the display panel 110 and a side portion 456a disposed between the first side portion 455b and the second side portion 455c of the cover bottom 455 to surround the side surface of the display panel 110 and the cover bottom 455. Further, the guide panel 456 can include a first horizontal portion 456b which extends between the display panel 110 and the optical sheet 152 from the side portion 456a to fix the optical sheet 152 and a second horizontal portion 456c which extends outward from the side portion 456a to support the rear edge of the cover glass 140.

Further, for example, a first screw hole H1 can be formed in the first side portion 455b of the cover bottom 455, and a second screw hole H2 can be formed in the side portion 456a of the guide panel 456 at a position corresponding thereto.

In the state in which the side portion 456a of the guide panel 456 is inserted and fixed between the first side portion 455b and the second side portion 455c of the cover bottom 455, the screw 460 can be fastened to the first side portion 455b of the cover bottom 455 through the first screw hole H1 and the second screw hole H2 to firmly fix the two parts.

As described above, the cover bottom 455 according to the fourth embodiment of the present disclosure can increase rigidity and minimize deformation by applying a double partition wall structure.

In particular, the structural stability is enhanced by inserting and fixing the side portion 456a of the guide panel 456 between the first side portion 455b and the second side portion 456c of the cover bottom 455, and the guide panel 456 is accurately fastened with the side surface of the cover bottom 455, so that the fixing force can be maintained even after assembly. Accordingly, the coupling force between the cover bottom 455, the display panel 110, and the guide panel 456 can be further strengthened, and the durability of the entire structure can be increased.

Further, in the fourth embodiment of the present disclosure, the fastening strength between the cover bottom 455 and the guide panel 456 is increased to effectively suppress the flow between the components. The guide panel 456 is fastened with the side surface of the cover bottom 455 to maintain a strong fixing force even after assembly. As a result, fine movement or vibration between parts is minimized, and generation of high-frequency vibration noise can be reduced. The flow suppression between parts also contributes to increasing the durability of the product, and allows stable performance to be maintained even when used for a long time.

As a result, the present disclosure can increase the reliability of the product and meet the customer's needs through increased rigidity, anti-deformation, noise-blocking effect, enhanced shock and vibration durability, and lightweight design.

The example embodiments of the present disclosure can also be described as follows:

A display device according to an example embodiment of the present disclosure can include a display panel configured to display images, a cover glass disposed above the display panel, a cover bottom disposed below the display panel and configured integrally by including a lower portion and a first side portion and a second side portion disposed inside the first side portion, and a guide panel configured to surround the display panel and the cover bottom under the cover glass and to be laterally fastened to the first side portion of the cover bottom.

The display device can further include a backlight unit disposed below the display panel, the backlight unit can include a light source accommodated in the cover bottom, a light guide plate which supplies a surface light source to the display panel through the light source, a reflection plate disposed on the rear surface of the light guide plate, and a plurality of optical sheets disposed on the upper surface of the light guide plate.

The guide panel can include a side portion disposed on side surfaces of the display panel and the cover bottom to surround the side surfaces of the display panel and the cover bottom, a first horizontal portion extending from the side portion between the display panel and the optical sheet to fix the optical sheet, and a second horizontal portion extending outward from the side portion to support a rear edge of the cover glass.

The side portion of the guide panel can protrude perpendicularly to the first horizontal portion so as to enclose the side surface of the display panel.

A rear edge of the display panel can be seated on the first horizontal portion of the guide panel through the first adhesive member, and a rear edge of the cover glass can be seated on the second horizontal portion of the guide panel through the second adhesive member.

A plurality of first screw holes can be provided in the first side portion of the cover bottom, and a plurality of second screw holes can be provided in the side portion of the guide panel so as to correspond to the first screw hole.

The lower portion of the cover bottom supports the backlight unit, the first side portion is located at an outer side and is fastened to the side portion of the guide panel, and the second side portion is located inside the first side portion to accommodate the backlight unit.

The first side portion can vertically extend from an edge of the lower portion in an upward direction, and the second side portion can vertically extend from an inner side of the first side portion in an upward direction from a part of the lower portion.

The first side portion and the second side portion can have different thicknesses.

At least one side of the display device can have a single partition wall structure including only the first side portion, and the other sides can have a double partition wall structure including the first and second side portions.

The first side portion of the cover bottom on at least one side can have a first thickness, and the first side portion of the cover bottom on the other sides can have a second thickness thinner than the first thickness.

All side surfaces of the display device can have a double partition wall structure including the first and second side portions.

The lower portion and a connection portion of the first side portion can have a rounded shape.

The cover bottom can further include a third side portion provided between the first side portion and the second side portion.

A plurality of third screw holes can be provided in the third side portion to correspond to the second screw holes, and a screw can be fastened through the first, second, and third screw holes.

The guide panel can include a side portion disposed between a side surface of the display panel and the first side portion and the second side portion of the cover bottom to surround the side surfaces of the display panel and the cover bottom, a first horizontal portion extending from the side portion between the display panel and the optical sheet to fix the optical sheet, and a second horizontal portion extending outward from the side portion to support the rear edge of the cover glass.

A display device according to another example embodiment of the present disclosure can include a display panel configured to display an image, a cover glass disposed above the display panel, a backlight unit disposed below the display panel and including an optical sheet, a cover bottom disposed below the display panel and the backlight unit and integrally configured to include a lower portion, a first side portion, and a second side portion disposed inside the first side portion, and a guide panel configured to surround side surfaces of the display panel and the cover bottom, including a side portion disposed under the cover glass between a side surface of the display panel and the first and second side portions of the cover bottom.

The guide panel can further include a first horizontal portion extending from the side portion between the display panel and the optical sheet to fix the optical sheet, and a second horizontal portion extending from the side portion in an outward direction to support a rear edge of the cover glass.

Although the example embodiments of the present disclosure have been described in detail with reference to the accompanying drawings, the present disclosure is not limited thereto and can be embodied in various forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A display device, comprising:
a display panel configured to display an image;
a cover glass disposed above the display panel;
a cover bottom disposed below the display panel and integrally configured to include a lower portion, a first side portion, and a second side portion disposed inside the first side portion; and
a guide panel configured to surround the display panel and the cover bottom under the cover glass and laterally fastened to the first side portion of the cover bottom.

2. The display device according to claim 1, further comprising:
a backlight unit disposed below the display panel,
wherein the backlight unit includes:
a light source accommodated in the cover bottom;
a light guide plate configured to supply a surface light source to the display panel through the light source;
a reflection plate disposed on a rear surface of the light guide plate; and
a plurality of optical sheets disposed on a top surface of the light guide plate.

3. The display device according to claim 2, wherein the guide panel includes:
a side portion which is disposed on side surfaces of the display panel and the cover bottom to surround the side surfaces of the display panel and the cover bottom;
a first horizontal portion which extends from the side portion between the display panel and the optical sheet to fix the optical sheet; and
a second horizontal portion which extends outward from the side portion to support a rear edge of the cover glass.

4. The display device according to claim 3, wherein the side portion of the guide panel protrudes perpendicularly to the first horizontal portion so as to enclose the side surface of the display panel.

5. The display device according to claim 3, wherein a rear surface edge of the display panel is seated on the first horizontal portion of the guide panel through a first adhesive member, and
wherein a rear surface edge of the cover glass is seated on the second horizontal portion of the guide panel through a second adhesive member.

6. The display device according to claim 3, wherein a plurality of first screw holes are provided in the first side portion of the cover bottom, and
wherein a plurality of second screw holes are provided in the side portion of the guide panel so as to correspond to the plurality of first screw holes.

7. The display device according to claim 3, wherein the lower portion of the cover bottom supports the backlight unit,
wherein the first side portion of the cover bottom is positioned at an outer side to be fastened to the side portion of the guide panel, and
wherein the second side portion of the cover bottom is positioned at an inner side of the first side portion to accommodate the backlight unit.

8. The display device according to claim 1, wherein the first side portion of the cover bottom vertically extends from an edge of the lower portion of the cover bottom in an upward direction, and
wherein the second side portion of the cover bottom vertically extends from an inner side of the first side portion in an upward direction from a part of the lower portion.

9. The display device according to claim 1, wherein the first side portion of the cover bottom and the second side portion of the cover bottom have different thicknesses.

10. The display device according to claim 1, wherein at least one side of the display device is configured as a single partition wall structure including only the first side portion of the cover bottom, and another side of the display device is configured as a double partition wall structure including the first and second side portions of the cover bottom.

11. The display device according to claim 10, wherein the first side portion of the cover bottom on at least one side has a first thickness, and
wherein the first side portion of the cover bottom on another side has a second thickness which is thinner than the first thickness.

12. The display device according to claim 1, wherein all side surfaces of the display device are configured with a double partition wall structure including the first and side portions of the cover bottom.

13. The display device according to claim 1, wherein the lower portion of the cover bottom and a connection portion of the first side portion of the cover bottom have a rounded shape.

14. The display device according to claim 6, wherein the cover bottom further includes a third side portion provided between the first side portion and the second side portion.

15. The display device according to claim 14, wherein a plurality of third screw holes are provided in the third side portion of the cover bottom so as to correspond to the plurality of second screw holes, and
wherein a screw is fastened through the plurality of first, second, and third screw holes.

16. The display device according to claim 2, wherein the guide panel includes:
a side portion disposed between a side surface of the display panel and the first side portion and the second side portion of the cover bottom to surround the side surfaces of the display panel and the cover bottom;
a first horizontal portion extending from the side portion of the guide panel between the display panel and the optical sheet to fix the optical sheet; and
a second horizontal portion extending from the side portion of the guide panel in an outward direction to support the rear edge of the cover glass.

17. A display device, comprising:
a display panel configured to display an image;
a cover glass disposed above the display panel;
a backlight unit disposed below the display panel and including an optical sheet;
a cover bottom disposed below the display panel and the backlight unit, and integrally configured to include a lower portion, a first side portion, and a second side portion disposed inside the first side portion; and
a guide panel configured to surround side surfaces of the display panel and the cover bottom, the guide panel including a side portion disposed under the cover glass between a side surface of the display panel and the first and second side portions of the cover bottom.

18. The display device according to claim 17, wherein the guide panel further comprises:
a first horizontal portion extending from the side portion of the guide panel between the display panel and the optical sheet to fix the optical sheet; and
a second horizontal portion extending from the side portion of the guide panel in an outward direction to support a rear edge of the cover glass.

19. The display device according to claim 17, wherein the first side portion of the cover bottom and the second side portion of the cover bottom have different thicknesses.

20. The display device according to claim 17, wherein the cover bottom further includes a third side portion provided between the first side portion and the second side portion.
